(19) United States
(12) Patent Application Publication
(10) Pub. No.: US 2026/0215424 A1
(43) Pub. Date: Jul. 30, 2026

(54) LIQUID AGRICULTURAL FORMULATIONS OF PPO-INHIBITOR HERBICIDES

(71) Applicant: BASF AGRO B.V., Arnhem (NL)

(72) Inventors: Claude Taranta, Limburgerhof (DE); Stephan Koehler, Ludwigshafen (DE); Katja Marxer, Limburgerhof (DE); Hermann Castro, Chapel Hill, NC (US)

(21) Appl. No.: 19/137,335

(22) PCT Filed: Dec. 13, 2023
(86) PCT No.: PCT/EP2023/085533

§ 371 Date: Jun. 10, 2025

(30) Foreign Application Priority Data
Dec. 14, 2022 (EP) 22213466.0

(51) Int. Cl. A01N 43/54; A01N 25/02; A01N 25/10; A01N 25/30; A01N 43/84; A01P 13/02

(52) U.S. Cl. CPC A01N 43/54; A01N 25/02; A01N 25/10; A01N 25/30; A01N 43/84; A01P 13/02

(57) ABSTRACT

The present invention relates to liquid agricultural formulations which contain at least one herbicide of the group of inhibitors of protoporphyrinogen-IX-oxidase (PPO-inhibitors), which are in particular selected from saflufenacil and trifludimoxazin, where the PPO inhibitor is present in dissolved form. The formulations contain: a) at least one herbicide of the group of PPO-inhibitors as a component A, b) at least one polymer as component B which is selected from the group consisting of b.1 polymers P1 comprising i) repeating units (1) selected from the group consisting of poly-C2-C4-alkyleneoxides and polymerized N-vinyl lactams; ii) repeating units (2) selected from the group consisting of polymerized vinylesters of C2-C3-alkanoic acids, where the total amount of repeating units (1) and (2) is at least 95% by weight, based on the total weight of the polymer P1; b.2 polymers P2 comprising iii) repeating units (3) of one or more polymerized monomers M2a selected from the group consisting of monoethylenically unsaturated monomers having a poly-C2-C4-alkyleneoxide group; iv) repeating units (4) of one or more polymerized monomers M2b selected from the group consisting polymerized N-vinyl lactams, polymerized N—Ci-Ce-alkyl acrylamide and polymerized N—Ci-Ce-alkyl methacrylamide; and v) repeating units (5) of one or more polymerized monomers M2c selected from the group consisting of polymerized Ci-Ce-alkylesters of acrylic acid, and polymerized Ci-Ce-alkylesters of methacrylic acid; where the total amount of repeating units (3), (4) and (5) is at least 90% by weight, based on the total weight of the polymer P2; c) at least one organic solvent as component C, which comprises at least 30% by weight, based on the total weight of the organic solvent of a solvent C.1 which has a solubility in deionized water of at least 100 g/L as determined at 20° C. and 1 bar and optionally up to 70% by weight of one or more solvents C2, which have a solubility in deionized water of less than 100 g/L as determined at 20° C. and 1 bar; d) at least one anionic emulsifier as a component D.

The present invention relates to liquid agricultural formulations which contain at least one herbicide of the group of inhibitors of protoporphyrinogen-IX-oxidase (PPO-inhibitors), which are in particular selected from saflufenacil and trifludimoxazin, where the PPO inhibitor is present in dissolved form.

### BACKGROUND ON THE INVENTION

Some organic agrochemical pesticide compounds, like herbicides, fungicides, insecticides—or pesticides in general—are often applied in the form of a dilute aqueous composition in order to achieve a good interaction with the target organisms, which can be weeds, fungi or pests like invertebrate pests. Whereas some of these agrochemical pesticides are water soluble, a considerable amount of organic pesticide compounds are only sparingly or even insoluble in water. In particular, herbicides of the group of PPO-inhibitors, especially saflufenacil and trifludimoxazin, are only sparingly soluble in various liquid media, particularly in an aqueous media. Therefore, it is extremely challenging to provide a stable liquid formulation containing PPO-inhibitors, especially saflufenacil or trifludimoxazin.

Organic herbicides having a limited solubility in water are often formulated as wettable powders or granules, as water-dispersible granules (WDG) or as aqueous suspension concentrates (SC). Such formulations of insoluble or sparingly water soluble herbicides are generally diluted with water for use in the field to a predetermined concentration and often produced as a spray liquid.

Suspension concentrates are formulations, wherein the active ingredient is present in the form of finely divided solid particles which are suspended in an aqueous dispersing medium utilizing surface-active compounds, i.e. surfactants, such as wetting agents, dispersants and rheological or suspending aids for stabilizing the active ingredient particles in the dispersing medium. However, problems are often encountered with SC's as a result of settling during prolonged storage or storage at elevated temperatures, the resistance of settled particles to re-suspension and the formation of crystalline material upon storage. As a consequence, the formulations are difficult to handle and the bioefficacy may be inconsistent which is in particular problematic for highly active modern herbicides.

In wettable powders or granules the herbicide compound is present in the form of particles. When wettable powders or granules are diluted in water for field application, the particles of the powder or granules have to disintegrate in water to achieve a uniform distribution of the herbicide compound in the aqueous dilution. Unfortunately, disintegration of the particles is often hampered, if the solid formulation has been stored for prolonged time or in opened packages. Hindered disintegration may result in inconsistent bioefficacy.

WO 2011/023759 describes an aqueous suspension concentrate formulation for plant protection comprising saflufenacil in the form of its crystalline anhydrate; at least one non-ionic surfactant selected from polyoxyethylene-polyoxy-C₃-C₄-alkylene blockcopolymers; at least one anionic surfactant comprising at least one arylsulfonate group; and water; wherein the pH value of the formulation is in the range of 3 to 7.

WO 2011/070051 describes a liquid suspension concentrate formulations for plant protection comprising saflufenacil in the form of the crystalline anhydrate; at least one diluent selected from: hydrocarbon solvents having a boiling point of at least 100° C.; and C₁-Cg-alkyl esters of C₈-C₂₆-fatty acids, mono- and di-C₁-C₄-alkyl amides of C₈-C₂₆-fatty acids; at least two different non-ionic surfactants selected from poly-ethoxylate-co-C₃-C₄-alkoxylates of C₃-C₂₀-alkanols, polyethoxylates of C₈-C₂₂-alkanols, polyester-polyoxyethylene block copolymers, polyethoxylates of mono-, di- or tristyryl phenols and polyethoxylates of vegetable oils; and at least one anionic surfactant selected from C₁-C₁₆-alkylarene sulfonates.

WO 2007/051743 discloses the use of a graft copolymers obtained by free-radical polymerization of N-vinyllactam and vinyl esters, such as vinylacetate in the presence of a polyether, such as polyethyleneoxide, as solubilizer for water insoluble compounds, such as agrochemical pesticides. WO2007/051743 does not disclose liquid formulations, let alone of PPO inhibitors, such as saflufenacil or trifludimoxazin.

US 2011/0245082 discloses pesticide compositions, in particular aqueous suspension concentrates containing a graft copolymer obtained by free-radical polymerization of N-vinyllactam and vinyl esters, such as vinylacetate in the presence of a polyether, such as polyethyleneoxide. It is suggested that the graft copolymer increases the activity of pesticides, in particular of fungicides. US 2011/0245082 does not disclose liquid formulations of PPO inhibitors, such as saflufenacil or trifludimoxazin.

WO 2013/149856 discloses liquid emulsifyable concentrate formulations of water-insoluble organic pesticide compounds, which for stabilization of the pesticide in the formulation contain a terpolymer of a polymerized amide monomer A selected from N-vinyl lactams and N-alkyl acrylamides, a monomer B selected from poly(C₂-6 alkylene glycol) (meth)acrylates and mono C₁₋₂₂ alkyl terminated poly(C₂₋₆ alkylene glycol) (meth)acrylates and a monomer C selected from C₁-C₈alkyl (meth)acrylates. The formulations are not suitable for formulating high loads of the organic pesticide compounds. In case of herbicides of the group of PPO inhibitors, in particular PPO inhibitors of the group of saflufenacil and trifludimoxazin, the dilution stability is not particularly satisfactory.

The storage stability problems associated with suspension concentrates, in particular sediment formation, can in principle be circumvented by formulations in which the active ingredient is present in dissolved form, such as emulsifiable concentrates or DC formulations. However, in the case of herbicides from the group of PPO inhibitors, especially saflufenacil and triflumoxazine, this is not readily possible. Such herbicides often have only very low solubility in organic solvents such as those used in the production of emulsion concentrates. When formulated in water-soluble solvents, the problem arises that these active ingredients crystallize out when diluted with water and do not form a stable aqueous suspension. This leads to problems in the application of the active ingredients. Furthermore, formulations containing a dissolved pesticide compound may have a poor chemical stability and suffer from degradation of the pesticide.

### SUMMARY OF THE INVENTION

There is an ongoing need for liquid formulations of PPO inhibitors, in particular liquid formulations of saflufenacil or trifludimoxazin, which provide sufficient stability in terms of chemical stability and physical stability and which allow for high loads with these pesticides. Moreover, the formulations should have high dilution stability, i. e. upon dilution with water they form a stable emulsion or dispersion of the PPO inhibitor without forming sediment or creaming.

It is, therefore, an object of the present invention to provide stable herbicide formulations of at least one herbicide of the group of PPO-inhibitors, especially of saflufenacil and/or trifludimoxazin. Such herbicide formulation should especially exhibit both chemical and physical stability, in particular a good storage stability, as well as high dilution stability.

This objective is achieved by the liquid agricultural formulations at least one herbicide of the group of PPO-inhibitors comprising a specific polymer and a solvent/emulsifier combination as described herein.

Therefore, a first aspect of the present invention relates to liquid agricultural formulations which contain
a) at least one herbicide of the group of PPO-inhibitors as a component A,
b) at least one polymer as component B which is selected from the group consisting of
   b.1 polymers P1 comprising
      i) repeating units (1) selected from the group consisting of poly-C₂-C₄-alkyleneoxides and polymerized N-vinyl lactams;
      ii) repeating units (2) selected from the group consisting of polymerized vinylesters of C₂-C₃-alkanoic acids, where the total amount of repeating units (1) and (2) is at least 95% by weight, based on the total weight of the polymer P1;
   b.2 polymers P2 comprising
      iii) repeating units (3) of one or more polymerized monomers M2a selected from the group consisting of monoethylenically unsaturated monomers having a poly-C₂-C₄-alkyleneoxide group;
      iv) repeating units (4) of one or more polymerized monomers M2b selected from the group consisting polymerized N-vinyl lactams, polymerized N—C₁-C₆-alkyl acrylamide and polymerized N—C₁-C₆-alkyl methacrylamide; and
      v) repeating units (5) of one or more polymerized monomers M2c selected from the group consisting of polymerized C₁-C₆-alkylesters of acrylic acid, and polymerized C₁-C₆-alkylesters of methacrylic acid;
      where the total amount of repeating units (3), (4) and (5) is at least 90% by weight, based on the total weight of the polymer P2;
c) at least one organic solvent as component C, which comprises at least 30% by weight, based on the total weight of the organic solvent of a solvent C.1 which has a solubility in deionized water of at least 100 g/L as determined at 20° C. and 1 bar and optionally up to 70% by weight of one or more solvents C₂, which have a solubility in deionized water of less than 100 g/L as determined at 20° C. and 1 bar
d) at least one anionic surfactant as a component D,
where the component A is dissolved in a mixture comprising the components B, C and D.

Furthermore, the present invention also relates to a process for preparing the liquid formulation as defined herein, which comprises mixing the components A, B and C and D.

A further aspect of the present invention relates to the use of said liquid formulation, as defined herein, for controlling growth of undesired plants.

Yet, a further aspect of the present invention relates to a method for controlling growth of undesired plants comprising the step of applying the formulation, as defined herein, onto the undesired plants, on parts of the undesired plants or on the area where the undesired plants grow or may grow.

Yet, a further aspect of the present invention relates to a method for improving the dilution stability of liquid agricultural formulations of a herbicide of the group of PPO-inhibitors which comprises including a combination of at least one polymer P1 or P2 as defined in herein and at least one organic solvent C.1 which has a solubility in deionized water of at least 100 g/L as determined at 20° C. and 1 bar into the formulation.

The liquid formulations according to the present invention are associated with several benefits. The liquid formulations according to the present exhibit excellent stabilities, especially outstanding chemical and physical stability and storage stability, even at high loads of the PPO inhibitor of 20% by weight or higher, based on the weight of the formulations. In particular, the liquid formulations of the present invention show a low degradation of the PPO inhibitor herbicide component contained in the formulation. Furthermore, said liquid formulation has high biological effectiveness and high loading with herbicidal active ingredients. In particular, the formulations of the present provide an improved uptake of PPO inhibitor herbicide by plants treated with a formulation of the present invention. Moreover, the liquid formulations of the present invention show good dilution stability and the aqueous dilutions remain stable in a diluted form and therefore, they are easily to handle and apply by the users.

### DETAILED DESCRIPTION OF THE INVENTION

As used herein “herbicide” refers to one or more agents, compounds and/or compositions having herbistatic and/or herbicidal activity.

As used herein, the terms “controlling” and “combating” are synonyms, referring to inhibition of growth, control of growth, reduction of growth or complete destruction of undesired plants. Preferably, the growth of the harmful plant(s) is essentially diminished (60-79%), more preferably the growth of the harmful plant(s) is largely or fully suppressed (80-100%), and in particular the growth of the harmful plant(s) is almost fully or fully suppressed (90-100%).

As used herein, the terms “undesirable vegetation”, “undesirable species”, “undesirable plants”, “undesired plants”, “harmful plants”, “undesirable weeds”, “volunteer plants” or “harmful weeds” are used synonymously.

As used herein, “pre emergence” refers to an herbicide treatment that is applied to an area before the weeds have germinated and emerged from the ground or growing medium. As used herein, “post emergence” refers to an herbicide treatment that is applied to an area after the weeds have germinated and emerged from the ground or growing medium.

As used herein, “burndown” refers to when an herbicide is used to reduce weed presence at the time of treatment. Burndown is often used in minimum or no-till fields because the weeds cannot be managed by tilling the soil. The burndown application may be used post-harvest and/or prior to crop emergence. Burndown is especially useful against weeds that emerge between growing seasons.

In general, terms mentioned in their plural form refer to a situation wherein only the singular term applies as well unless specifically expressed otherwise.

In the context of the present invention, the term “liquid formulation” at least at ambient conditions, i.e. at 20° C. and 1013 mbar, in particular at a temperature of 0° C. or higher. In particular, the a liquid formulation is understood as a formulation having a dynamic viscosity determined at 20° C. at a shear rate of 100 s⁻¹ of at most 2000 mPa·s, in particular of at most 1000 mPa·s and typically in the range of 20 to 2000 mPa·s.

The formulations of the present invention are virtually homogeneous. The term “homogeneous” is understood that all non-liquid components of the formulation, especially the PPO inhibitor herbicide is dissolved in the liquid phase of the formulation at 20° C. and 1013 mbar or at least forms a stable colloidal solution in the solvent/emulsifier composition forming the fluid phase of the formulation. In particular, the formulation is characterized by having either no measurable particle size or a particle size of at most 50 nm, as determined at a temperature in the range of 20 to 25° C. by light scattering. In particular, the formulation is virtually transparent or translucent, i.e. the turbidity of the formulation, as expressed in light transmittance (LD100 value), as determined photometrically with 1 cm cuvette, is at least 10%, preferably at least 50%, more preferably at least 70%.

Here and throughout the specification, the prefixes Cₙ-Cₘ used in connection with compounds or molecular moieties each indicate a range for the number of possible carbon atoms that a molecular moiety or a compound can have. The term “C₁-Cₙ alkyl” denominates a group of linear or branched saturated hydrocarbon radicals having from 1 to n carbon atoms. The term “Cₙ/Cₘ alkyl” denominates a mixture of two alkyl groups, one having n carbon atoms while the other having m carbon atoms.

For example, the term C₁-C₂₀ alkyl denominates a group of linear or branched saturated hydrocarbon radicals having from 1 to 20 carbon atoms, while the term C₁-C₄ alkyl denominates a group of linear or branched saturated hydrocarbon radicals having from 1 to 4 carbon atoms and the C₅-C₂₀ alkyl denominates a group of linear or branched saturated hydrocarbon radicals having from 5 to 20 carbon atoms. Examples of alkyl include but are not limited to methyl, ethyl, n-propyl, isopropyl, n-butyl, sec-butyl, isobutyl, tert-butyl, 2-methylpropyl (isopropyl), 1,1-dimethylethyl (tert-butyl), pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-heptyl, n-octyl, 2-octyl, 2-ethylhexyl, nonyl, isononyl, decyl, undecyl, dodecyl, tridecyl, isotridecyl, tetradecyl, pentadecyl, hexadecyl, heptadecyl, octadecyl, nonadecyl, eicosyl, heneicosyl docosyl and in case of nonyl, isononyl, decyl, undecyl, dodecyl, tridecyl, isotridecyl, tetradecyl, pentadecyl, hexadecyl, heptadecyl, octadecyl, nonadecyl, eicosyl, heneicosyl docosyl their isomers, in particular mixtures of isomers such as “isononyl”, “isodecyl”. Examples of C₁-C₄-alkyl are for example methyl, ethyl, propyl, 1-methylethyl, butyl, 1-methylpropyl, 2-methylpropyl or 1,1-dimethylethyl.

Here and throughout the specification, the term “ethylenically unsaturated monomer” is understood that the monomer has at least one C═C double bond, e.g. 1, 2, 3 or 4 C═C double bonds, which are radically polymerizable.

Here and throughout the specification, the term “(meth)acryl” includes both acryl and methacryl groups. Hence, the term “(meth)acrylate” includes acrylate and methacrylate and the term “(meth)acrylamide” includes acrylamide and methacrylamide.

Here and throughout the specification, the terms “wt.-%” and “% by weight (% b.w.)” are used synonymously.

The liquid formulation of the invention comprises at least one herbicide of the group of inhibitors of protoporphyrinogen-IX-oxidase (PPO inhibitor). PPO inhibitors are compounds, which have a mode of action comprising the inhibition of a step of the chlorophyll biosynthesis in plants and which belong to the group E of the HRAC classification system (see HRAC, Classification of Herbicides According to Mode of Action, http://www.plantprotection.org/hrac/MOA.html).

PPO inhibitors have typically the following chemical formula (I):

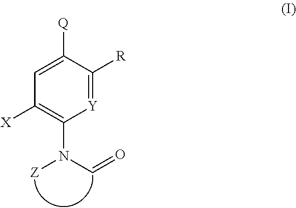

where the moiety

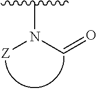

represents an N-bound heterocycle of the formula (a), (b), (c), (d), (e), (f) or (g)

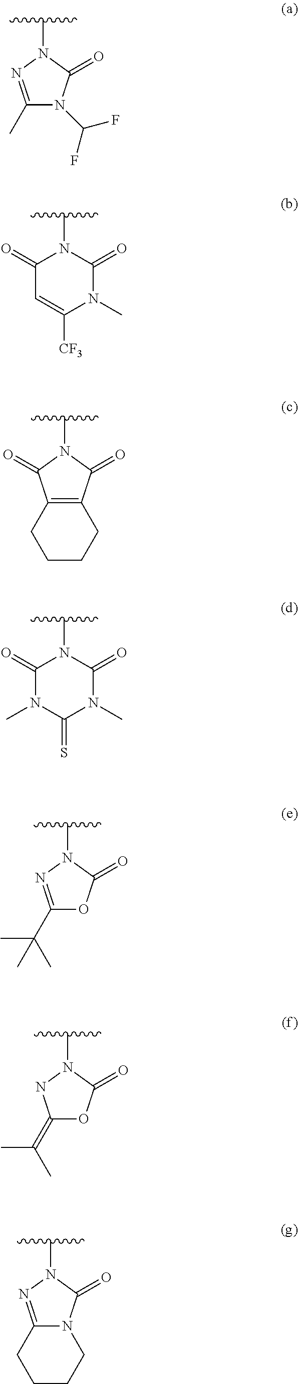

and where the other variables in formula (I) have the following meanings
X is H, F or Cl, in particular F;
Y is N or CH;
Q is Cl
R is a radical of the following formulae (1), (2), (3), (4), (5), (6), (7), (8), (9), (10) or (11):

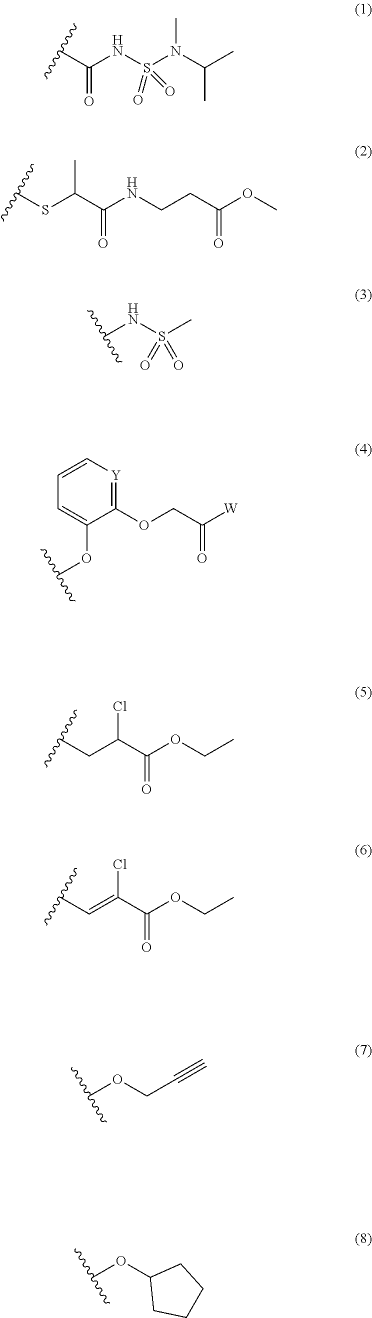

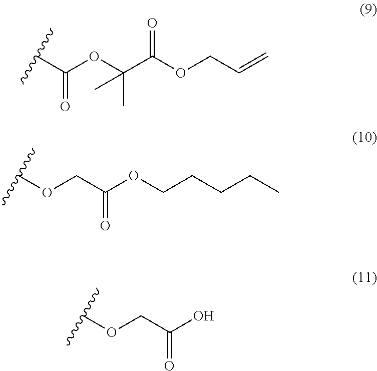

where Y in formula (4) is CH or N and W is OCH₃, OC₂H₅ or NHSO₂CH₃;
or Q and R together form one of the moieties (i), (ii)

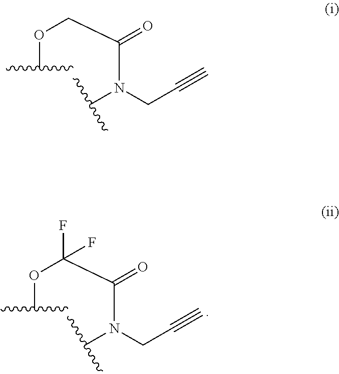

The dashed line in the groups of the formulae (a) to (g), (1) to (11), (i) and (ii) indicate the points of their attachment to the remainder of the formula (I).

Examples of compounds of the formula (I) include, for example: azafenidin, butafenacil, carfentrazone, carfentrazone-ethyl, cinidon-ethyl, flumiclorac, flumiclorac-pentyl, flumioxazin, fluthiacet, fluthiacet-methyl, oxadiargyl, oxadiazon, pentoxazone, profluazol saflufenacil, sulfentrazone, thidiazimin, tiafenacil, trifludimoxazin, ethyl [3-[2-chloro-4-fluoro-5-(1-methyl-6-trifluoromethyl-2,4-dioxo-1,2,3,4-tetrahydropyrimidin-3-yl) phenoxy]-2-pyridyloxy]acetate (CAS 353292-31-6; S-3100), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2Hbenzo[1,4]oxazin-6-yl)-4,5,6,7-tetrahydro-isoindole-1,3-dione (CAS 1300118-96-0), 1-methyl-6-trifluoromethyl-3-(2,2,7-trifluoro-3-oxo-4-prop-2-ynyl-3,4-dihydro-2Hbenzo[1,4]oxazin-6-yl)-1H-pyrimidine-2,4-dione (CAS 1304113-05-0), 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (CAS 2158274-50-9), methyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-aceticacid methyl ester (CAS 2158275-73-9), 2-[[3-[[3-chloro-6-[3,6-dihydro-3-methyl-2,6-dioxo-4-(trifluoromethyl)-1 (2H)-pyrimidinyl]-5-fluoro-2-pyridinyl]oxy]-2-pyridinyl]oxy]acetic acid ethyl ester (CAS 2158274-56-5), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-N-(methylsulfonyl)-acetamide (CAS 2158274-53-2), and 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N-(methylsulfonyl)-acetamide (CAS 2158276-22-1).

A first group of particularly preferred PPO inhibitors are those of the formula (I-a)

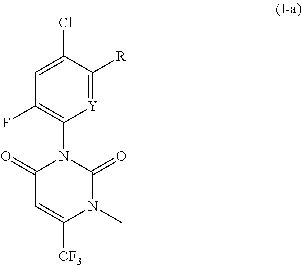

where R is a radical of the formulae (1), (2) or (4) and Y is CH or N.

Examples of compounds of the formula (I-a) include saflufenacil, tiafenacil, ethyl [3-[2-chloro-4-fluoro-5-(1-methyl-6-trifluoromethyl-2,4-dioxo-1,2,3,4-tetrahydropyrimidin-3-yl) phenoxy]-2-pyridyloxy]acetate (CAS 353292-31-6; S-3100), 1-methyl-6-trifluoromethyl-3-(2,2,7-trifluoro-3-oxo-4-prop-2-ynyl-3,4-dihydro-2Hbenzo[1,4]oxazin-6-yl)-1H-pyrimidine-2,4-dione (CAS 1304113-05-0), 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (CAS 2158274-50-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-aceticacid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]acetic acid ethyl ester (CAS 2158274-56-5), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-N-(methylsulfonyl)-acetamide (CAS 2158274-53-2), and 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N-(methylsulfonyl)-acetamide (CAS 2158276-22-1).

Particular preference is given to compounds of the formula (I-a) which are selected from the group consisting of saflufenacil, tiafenacil, ethyl [3-[2-chloro-4-fluoro-5-(1-methyl-6-trifluoromethyl-2,4-dioxo-1,2,3,4-tetrahydropyrimidin-3-yl) phenoxy]-2-pyridyloxylacetate (CAS 353292-31-6; S-3100), 2-[2-[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (CAS 2158274-50-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-aceticacid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]acetic acid ethyl ester (CAS 2158274-56-5), and 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N-(methylsulfonyl)-acetamide (CAS 2158276-22-1).

A second group of particularly preferred PPO inhibitors are those of the formula (I-b)

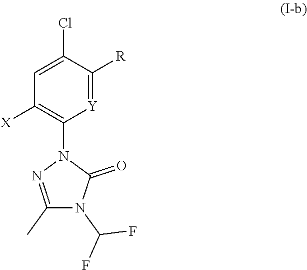

where X is F or Cl, R is a radical of the formulae (3), (4) or (5) and Y is CH or N. Examples of compounds of the formula (I-b) include carfentrazone, carfentrazone-ethyl, sulfentrazone, methyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4) with particular preference given to carfentrazone-ethyl, sulfentrazone, ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4).

A third group of particularly preferred PPO inhibitors are those of the formula (I), where

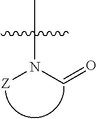

represents a radical of the formula (c), which are hereinafter referred to as compound (I-c). In compounds (I-c), X, Y, Q and R are as defined for formula (I), and X is in particular H or F, Y is in particular CH, Q is in particular CI and R is in particular a group (6), (10) or (11) or R and Q together form a radical (i) or (ii). Examples of compounds of the formula (I-c) include cinidon-ethyl, flumiclorac, flumiclorac-pentyl, flumioxazin, 2-(2,2,7-trifluoro-3-oxo-4-prop-2-ynyl-3,4-dihydro-2Hbenzo[1,4]oxazin-6-yl)-4,5,6,7-tetrahydro-isoindole-1,3-dione (CAS 1300118-96-0) with particular preference given to flumioxazin.

A fourth group of particularly preferred PPO inhibitors are those of the formula (I), where

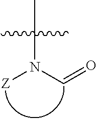

represents a radical of the formula (d), which are hereinafter referred to as compound (I-d). In compounds (I-d), X is in particular F, Y is CH or N and R and Q are as defined herein and in particular together form a radical (i) or (ii). Examples of compounds of the formula (I-c) include trifludimoxazin and 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7) with particular preference given to trifludimoxazin.

The formulations of the present invention are particularly suitable for providing high loads and storage stability of the formulation in those cases, where the PPO inhibitor is selected from the compounds of formulae (I-a) and (I-d), and where the PPO inhibitor herbicide of component A is especially selected from the group consisting of saflufenacil and trifludimoxazin.

Therefore, a particularly preferred group (1) of embodiments relates to the liquid formulations of the present invention, where the component A is a compound of the formula (I-a) and especially saflufenacil.

Yet, a particularly preferred group (2) of embodiments relates to the liquid formulations of the present invention, where the component A is a compound of the formula (I-d) and especially trifludimoxazin.

The concentration of the component A in the formulation of the present invention, in particular in the formulation of groups (1) and (2) of embodiments, is frequently at least 10% by weight, in particular at least 20% by weight and may be as high as 60% by weight, based on the total weight of the formulation. Preferably, the concentration of the component A in the formulation of the present invention, in particular in the formulation of groups (1) and (2) of embodiments, is in the range of 20 to 60% by weight, in particular in the range of 25 to 55% by weight, based on the total weight of the formulation.

According to the invention, the formulation of the invention contains at least one polymer P1 and/or P2 as a component A. Without being bound by theory, it is believed that the polymers of component B serve as a masker which hinder the crystallization of the PPO inhibitor, in particular when the formulation is diluted with water to the application concentration.

In the formulation of the present invention, the total amount of the component B is usually in the range of 1 to 10% by weight, in particular in the range of 2 to 8% by weight, based on the total weight of the formulation.

In a particular group (3) of embodiments, the component B comprises or is a polymer P1. Here and in the following, the above statements with regard to the groups (1) and (2) of embodiments also apply to the group (3) of embodiments.

The polymers P1 have repeating units (1) selected from the group consisting of poly-C₂-C₄-alkyleneoxides and polymerized N-vinyl lactams.

In the context of the polymer P1, the N-vinyl lactams preferably have 4 to 13 carbon atoms in the lactam ring. Examples are N-vinyl-2-pyrrolidone, N-vinylcaprolactam, N-vinylvalerolactam, N-vinyllaurolactam, N-vinyl-2-piperidone, N-vinyl-2-pyridone, N-vinyl-3-methyl-2-pyrrolidone, N-vinyl-4-methyl-2-pyrrolidone and N-vinyl-5-methyl-2-pyrrolidone. Preferred N-vinyl lactams are N-vinyl-2-pyrrolidone, N-viny-2-Icaprolactam and/or N-vinyl-2-piperidone. More preferred N-vinyl lactams are N-vinyl-2-pyrrolidone or N-vinyl-2-caprolactam and mixtures thereof.

In the context of the polymer P1, preferred poly-C₂-C₄-alkyleneoxides are in particular selected from polyethyleneoxides. Also suitable are poethylenoxide-co-propyleneoxides, polytetrahydrofurans, polypropyleneoxides or polybutyleneoxides, where the latter are typically obtained from 2-ethyloxirane or 2,3-dimethyloxirane, respectively. The poly-C₂-C₄-alkyleneoxides may have terminal C₁-C₁₀ alkoxy groups, such as methoxy, ethoxy, n-butoxy, isobutoxy, pentyloxy, hexyloxy, octyl, nonyloxy or decyloxy. ethyl, dodecyl, tridecyl or octadecyl radicals. Preferably, the poly-C₂-C₄-alkyleneoxides, in particular the polyethyleneoxides, are terminated by hydroxy groups.

The poly-C₂-C₄-alkyleneoxides, in particular the polyethyleneoxides, preferably have a number average weight in the range of 1,000 to 100,000 Dalton, more particularly in the range of 1,500 to 40,000 Dalton, especially in the range of 1,700 to 20,000 Dalton. The molecular weights are determined on the basis of the OH number measured as specified in DIN EN ISO 4629-1:2016-12 or DIN EN ISO 4629-2:2016-12.

In addition to the repeating units (1) the polymers P1 also comprise repeating units (2) selected from the group consisting of polymerized vinylesters of C₂-C₃-alkanoic acids. Examples are vinyl acetate and vinyl propionate. Particular preference is given to vinyl acetate. In accordance with the invention the polymer P1 may contain a single vinyl ester or a mixture of vinylesters.

The relative amount of repeating units (1) is typically in the range of 30 to 90% by weight, in particular in the range of 30 to 85% by weight, based on the total weight of the polymer P1. The relative amount of repeating units (2) is typically in the range of 10 to 70% by weight, in particular in the range of 15 to 70% by weight, based on the total weight of the polymer P1.

According to the invention the total amount of repeating units (1) and (2) in the polymers P1 is at least 90% by weight, in particular at least 95% by weight, based on the total weight of the polymer P1. In other words, the polymers P1 may comprise up to 10% by weight, in particular up to 5% by weight and especially less than 5% by weight of other repeating units which are different from the repeating units (1) and (2). Especially, the polymers P1 consist or essentially consist of the repeating units (1) and (2), i. e. total amount of repeating units (1) and (2) is at least 98% by weight or 100% by weight, based on the total weight of the polymer P1.

Typically, these other repeating units are units of polymerized monoethylenically unsaturated monomers M1c which are different from the monomers M1a and M1b non-ionic monomers or carboxylic acid monomers. These further monomers are e. g.
vinylcarboxamides such as N-vinylformamide, N-vinyl-N-methylformamide, N-vinylacetamide, N-vinyl-N-methylacetamide, N-vinyl-N-methylpropionamide, and N-vinylpropionamide. It is preferred to use N-vinylformamide and/or N-vinyl-N-methylacetamide. The copolymerized monomer units of N-vinylformamide and/or N-vinyl-N-methylacetamide may be partly or fully hydrolyzed;
monoethylenically unsaturated monocarboxylic and dicarboxylic acids or their anhydrides having 3 to 6 or 4 to 6 carbon atoms, such as acrylic acid, methacrylic acid, crotonic acid, maleic acid or anhydride, fumaric acid, itaconic acid or anhydride, and citraconic acid or anhydride;
primary amides of the aforementioned monoethylenically unsaturated carboxylic acids, such acrylamide and methacrylamide;
N-alkyl- and N,N-dialkylamides having alkyl radicals of 1 to 6 carbon atoms, such as N-methylacrylamide, N,N-dimethylacrylamide, N-methylmethacrylamide, N,N-dimethylmethacrylamide, N-ethylacrylamide, N-propylacrylamide, tert-butylacrylamide and tert-butylmethacrylamide, and also the basic (meth)acrylamides, such as 2-N,N-dimethylaminoethylacrylamide, 2-N,N-dimethylaminoethylmethacrylamide, 2-N,N-diethylaminoethylacrylamide, 2-N,N-diethylaminoethylmethacrylamide, 3-N,N-dimethylaminopropylacrylamide, 3-N,N-diethylaminopropylacrylamide, 3-N,N-dimethylaminopropylmethacrylamide and 3-N,N-diethylaminopropylmethacrylamide;
the esters of monoethylenically unsaturated carboxylic acids with C₁ to C₆ alkanols, such as methyl acrylate, methyl methacrylate, ethyl acrylate, and ethyl methacrylate,
the esters of monoethylenically unsaturated carboxylic acids with glycols having 2 to 4 carbon atoms, in each case only one OH group in the glycols and polyglycols being esterified with an ethylenically unsaturated carboxylic acid, such as hydroxyethyl acrylate, hydroxyethyl methacrylate, hydroxypropyl acrylate, hydroxybutyl acrylate, hydroxypropyl methacrylate and hydroxybutyl methacrylate.

Usually, the polymers P1 have Fikentscher K values in the range from 5 to 70, preferably 10 to 60, more preferably from 15 to 50, measured in a 1% by weight ethanolic solution.

The molecular weight Mw (weight average) of the polymers P1 is usually in the range from 5,000 to 1,000,000 g/mol, preferably from 10,000 to 500,000 g/mol, more preferably from 15,000 to 300,000 g/mol, measured by gel permeation chromatography.

The polymers P1 may be linear or branched polymers or graft copolymers.

In a particularly preferred subgroup (3.1) of group (3) of embodiments, the polymer P1 is selected from the group of non-ionic graftcopolymers P1.1 having a poly-C₂-C₄-alkyleneoxide backbone and polymeric side chains grafted onto the polymeric backbone, where the polymeric side chains consist of polymerized nonionic monoethylenically unsaturated monomers M1 comprising a monomer M1a which is selected from vinylesters of C₂-C₃-alkanoic acids and optionally a monomer M1b which is selected from N-vinyl lactams.

The polymers P1.1 are principally known, e. g. from WO 2007/138053, WO 2007/051473, WO 2011/032916 and US 2011/0245082. They are typically prepared by polymerization of monomers M1a and optionally Monomers M1b, in particular by a combination of a monomers M1a and a monomer M1b, in the presence of a poly-C₂-C₄-alkyleneoxide.

In the context of the polymer P1.1, the monomer M1a is selected from vinylesters of C₂-C₃-alkanoic acids. Examples are vinyl acetate and vinyl propionate. Particular preference is given to vinyl acetate. In accordance with the invention the polymer P1.1 may contain a single vinyl ester or a mixture of vinylesters.

In the context of the polymer P1.1, the monomer M1b is an N-vinyl lactams as described above. Preferred N-vinyl lactams are N-vinyl-2-pyrrolidone, N-vinyl-2-caprolactam and/or N-vinyl-2-piperidone. Especially, the N-vinyl lactam M1b is N-vinyl-2-caprolactam or N-vinyl-2-pyrrolidone and mixtures thereof.

In the context of the polymer P1.1, preferred poly-C₂-C₄-alkyleneoxides are in particular selected from polyethyleneoxides. Also suitable are polyethylenoxide-co-propyleneoxides, polytetrahydrofurans, polypropyleneoxides or polybutyleneoxides as described above. Preferably, the poly-C₂-C₄-alkyleneoxides, in particular the polyethyleneoxides, are terminated by hydroxy groups. In the context of the polymers P1.1, the poly-C₂-C₄-alkyleneoxides, in particular the polyethyleneoxides, preferably have a number average weight in the range of 1,000 to 100,000 Dalton, more particularly in the range of 1,500 to 40,000 Dalton, especially in the range of 1,700 to 20,000 Dalton. The molecular weights are determined on the basis of the OH number measured as specified in DIN EN ISO 4629-1:2016-12 or DIN EN ISO 4629-2:2016-12.

The polymers P1.1 frequently comprise
5 to 50% by weight, in particular from 7 to 35% by weight, especially 10 to 30% by weight of the poly-C₂-C₄-alkyleneoxide backbone, which is in particular a polyethyleneoxide backbone;
10 to 50% by weight, in particular from 15 to 40% by weight, especially 20 to 35% by weight of polymerized vinylesters of C₂-C₃-alkanoic acids (monomer M1a), which is in particular vinyl acetate, and
30 to 80% by weight, in particular from 30 to 70% by weight, especially 40 to 60% by weight, of polymerized N-vinyl lactams, which is in particular N-vinyl carprolactam (monomer M1b),
   wherein all values given in % by weight refer to the total weight of the polymer P1.1 and where the total amount of the poly-C₂-C₄-alkyleneoxide backbone and the polymerized monomers M1a and M1b is at least 90% by weight, in particular at least 95% by weight, especially at least 98% by weight or 100% by weight, based on the total weight of the polymer P1.1.

Alternatively, the polymers P1.1 frequently comprise
30 to 80% by weight, in particular from 35 to 70% by weight of the poly-C₂-C₄-alkyleneoxide backbone, which is in particular a polyethyleneoxide backbone;
20 to 70% by weight, in particular from 30 to 65% by weight of polymerized vinylesters of C₂-C₃-alkanoic acids, which is in particular vinyl acetate (monomer M1a), and
   wherein all values given in % by weight refer to the total weight of the polymer P1.1 and where the total amount of the poly-C₂-C₄-alkyleneoxide backbone and the polymerized monomers M1a is at least 90% by weight, in particular at least 95% by weight, especially at least 98% by weight or 100% by weight, based on the total weight of the polymer P1.1.

Usually, the polymers P1.1 have Fikentscher K values in the range from 10 to 60, preferably 20 to 50, more preferably from 25 to 40, measured in a 1% by weight ethanolic solution.

The molecular weight Mw (weight average) of the polymers P1.1 is usually in the range from 10,000 to 1,000,000 g/mol, preferably from 30,000 to 500,000 g/mol, more preferably from 60,000 to 300,000 g/mol, measured by gel permeation chromatography.

In a further particularly preferred subgroup (3.2) of group (3) of embodiments, the polymer P1 is selected from the group of non-ionic linear copolymers P1.2 of polymerized nonionic monoethylenically unsaturated monomers M comprising a monomer M1a which is vinylacetate and at least one monomer M1b which is selected from N-vinyl lactams.

The polymers P1.2 are principally known. They are typically prepared by copolymerization of monomers M1a and monomers M1b.

In the context of the polymer P1.2, the monomer M1a is selected from vinylesters of C₂-C₃-alkanoic acids. Examples are vinyl acetate and vinyl propionate. Particular preference is given to vinyl acetate. In accordance with the invention the polymer P1.2 may contain a single vinyl ester or a mixture of vinylesters.

In the context of the polymer P1.2, the monomer M1b is an N-vinyl lactams as described above. Preferred N-vinyl lactams are N-vinyl-2-pyrrolidone, N-vinyl-2-caprolactam and/or N-vinyl-2-piperidone. Especially, the N-vinyl lactam M1b is N-vinyl-2-pyrrolidone.

In particular, the polymers P1.2 comprise
30 to 80% by weight, in particular from 35 to 70% by weight of polymerized N-vinyl lactams, which is in particular N-vinyl caprolactam (monomer M1b),;
20 to 70% by weight, in particular from 30 to 65% by weight of polymerized vinylesters of C₂-C₃-alkanoic acids, which is in particular vinyl acetate (monomer M1a), and
   wherein all values given in % by weight refer to the total weight of the polymer P1.1 and where the total amount of the polymerized monomers M1a and M1b is at least 90% by weight, in particular at least 95% by weight, especially at least 98% by weight or 100% by weight, based on the total weight of the polymer P1.2.

Usually, the polymers P1.2 have Fikentscher K values in the range from 5 to 50, preferably 10 to 45, more preferably from 15 to 40, measured in a 1% by weight ethanolic solution.

The molecular weight Mw (weight average) of the polymers P1.2 is usually in the range from 5,000 to 500,000 g/mol, preferably from 10,000 to 300,000 g/mol, more preferably from 15,000 to 250,000 g/mol, measured by gel permeation chromatography.

In another particular group (4) of embodiments, the component B comprises or is a polymer P2. Here and in the following, the above statements with regard to the groups (1) and (2) of embodiments also apply to the group (4) of embodiments. The polymers P2 are known, e. g. from WO 2013/149856.

The polymers P2 contain repeating units (3) of polymerized monomers selected from the group consisting of monoethylenically unsaturated monomers having a poly-C₂-C₄-alkyleneoxide group. These monomers are hereinafter termed monomers M2a.

Suitable monomers M2a include, for example, monoesters of a poly(C₂-C₄-alkylene glycol) with acrylic acid or methacrylic acid, hereinafter termed poly(C₂-C₄-alkylene glycol) (meth)acrylates and monoethers of poly(C₂-C₄-alkylene glycol) with allyl alcohol, hereinafter termed poly(C₂-C₄-alkylene glycol) allyl ethers. The poly(C₂-C₄-alkylene glycol unit of the monomer M2a typically comprises 2 to 60, in particular 3 to 35 repeating units of the C₂-C₄-alkylene glycol. The poly(C₂-C₄-alkylene glycol) unit of the monomer M2a may have a terminal OH group but is preferably terminated with a C₁-C₂₂-alkyl group. In particular, the poly(C₂-C₄-alkylene glycol) unit of the monomer M2a, is a polyethylene glycol unit, in particular a polyethylene glycol unit which is terminated with a C₁-C₂₂-alkyl group.

C₁-C₂₂-alkyl denotes usually linear or branched, saturated alkyl groups having 1 to 22 carbon atoms. These alkyl groups are free of functional groups, such as aryl groups, hydroxyl groups, halogen groups or double or triple bonds.

Preferred monomers M2a are C₁-C₂₂-alkyl terminated poly(C₂-C₄-alkylene glycol) (meth)acrylates. Especially preferred monomer M2a are mono C₁-C₂₂-alkyl terminated poly(ethylene glycol) (meth)acrylates, in particular those having 3 to 35 repeating units of ethylene glycol.

The polymers P2 contain repeating units (4) of polymerized monomers M2b selected from the group consisting polymerized N-vinyl lactams, polymerized N—C₁-C₆-alkyl acrylamide and polymerized N—C₁-C₆-alkyl methacrylamide.

Suitable N-vinyl lactams are N-vinyl-2-pyrrolidone, N-vinyl-2-caprolactam and/or N-vinyl-2-piperidone. Preferred are N-vinyl-2-pyrrolidone, N-vinyl-2-caprolactam and mixtures thereof. Particularly preferred is N-vinyl-2-pyrrolidone.

Suitable N—C₁-C₆-alkyl (meth)acrylamides are N-methyl acrylamide, N-ethyl acrylamide, N-n-propyl acrylamide, N-iso-propyl acrylamide, N-n-butyl acrylamide, N-tert-butyl acrylamide, N-n-pentyl acrylamide, N-n-hexyl acrylamide, N-methyl methacrylamide, N-ethyl methacrylamide, N-n-propyl methacrylamide, N-iso-propyl methacrylamide, N-n-butyl methacrylamide, N-tert-butyl methacrylamide, N-n-pentyl methacrylamide, N-n-hexyl methacrylamide and mixtures thereof. Preferred are N—C₂-C₅-alkyl acrylamides, and more preferably N—C₃-C₄-alkyl acrylamides, wherein N-tert-butyl acrylamide is most preferred.

Preferably, the monomers M2b which form the units (4) of the polymer P2 comprise at least on N-vinyl lactam, in particular, N-vinyl-2-pyrrolidone. The N-vinyl lactam may be the sole monomers M2b. Preference is also given to monomers M2b which comprise a mixture of a N-vinyl lactam and a N—C₁-C₆-alkyl (meth)acrylamide, in particular a combination of N-vinyl-2-pyrrolidone and a N—C₂-C₅-alkyl acrylamide, especially a combination of N-vinyl-2-pyrrolidone and N-tert-butyl acrylamide.

The polymers P2 contain repeating units (5) of polymerized monomers selected from the group consisting of polymerized C₁-C₆-alkylesters of acrylic acid, and polymerized C₁-C₆-alkylesters of methacrylic acid. These monomers are hereinafter termed monomers M2c and C₁-C₆-alkyl (meth)acrylates, respectively. Suitable are methyl acrylate, ethyl acrylate, n-butyl acrylate, tert-butyl acrylate, methyl methacrylate, ethyl methacrylate, n-butyl methacrylate, tert-butyl methacrylate, and mixtures thereof. Preferred monomers M2c selected from C₁-C₄-alkyl (meth)acrylates. Especially, the monomer M2c is methyl methacrylate.

Optionally, the polymers P2 contain repeating units (6) of polymerized monomers other than monomers M2a, M2b and M2c. Preferably, the repeating units (6) are formed by polymerized monomers M2d selected from the group consisting of
monoethylenically unsaturated monocarboxylic and dicarboxylic acids or their anhydrides having 3 to 6 or 4 to 6 carbon atoms, such as acrylic acid, methacrylic acid, crotonic acid, maleic acid or anhydride, fumaric acid, itaconic acid or anhydride, and citraconic acid or anhydride;
primary amides of the aforementioned monoethylenically unsaturated carboxylic acids, such acrylamide and methacrylamide;
N,N-dialkylamides having alkyl radicals of 1 to 6 carbon atoms, such as NN,N-dimethylmethacrylamide, N-ethylacrylamide, N-propylacrylamide, tert-butylacrylamide and tert-butylmethacrylamide, and also the basic (meth)acrylamides, such as 2-N,N-dimethylaminoethylacrylamide, 2-N,N-dimethylaminoethylmethacrylamide, 2-N,N-diethylaminoethylacrylamide, 2-N,N-diethylaminoethylmethacrylamide, 3-N,N-dimethylaminopropylacrylamide, 3-N,N-diethylaminopropylacrylamide, 3-N,N-dimethylaminopropylmethacrylamide and 3-N,N-diethylaminopropylmethacrylamide;
the esters of monoethylenically unsaturated carboxylic acids with glycols having 2 to 4 carbon atoms, in each case only one OH group in the glycols and polyglycols being esterified with an ethylenically unsaturated carboxylic acid, such as hydroxyethyl acrylate, hydroxyethyl methacrylate, hydroxypropyl acrylate, hydroxybutyl acrylate, hydroxypropyl methacrylate and hydroxybutyl methacrylate.

Amongst the monomers M2d preference is given to monoethylenically unsaturated monocarboxylic acids having 3 to 6 carbon atoms, such as acrylic acid, methacrylic acid and combinations thereof. Generally, the amount of repeating units (6), if present does not exceed 10% by weight and, if present, is typically in the range of 0.5 to 10% by weight, in particular in the range of 1 to 8% by weight, based on the total weight of the repeating units (3), (4), (5) and (6) which form the polymer P2.

The polymer P2 generally comprises
1 to 40% by weight, in particular from 5 to 30% by weight of repeating units (3), which are in particular repeating units of monomers M2a selected from the group consisting of C₁-C₂₂-alkyl terminated poly(C₂-C₄-alkylene glycol) (meth)acrylates;
25 to 85% by weight, in particular from 30 to 80% by weight of repeating units (4) which are in particular repeating units of monomers M2b selected from N-vinyl lactams and combinations of a N-vinyl lactam and a N—C₁-C₆-alkyl (meth)acrylamide,
5 to 50% by weight, in particular from 10 to 40% by weight of repeating units (5) of polymerized monomers M2c which are in particular selected from C₁-C₄-alkyl (meth)acrylates,
   and optionally
0 to 10% by weight, in particular 0 to 8% by weight, e. g. 0.5 to 10% by weight, in particular 1 to 8% by weight of repeating units (6) of polymerized monomers M2d, which are in particular selected from monocarboxylic acids having 3 to 6 carbon atoms;
   wherein all values given in % by weight refer to the total weight of the polymer P2, i. e. the total weight of the repeating units (3), (4), (5) and optionally (6) which form the polymer P2.

In particular, the polymer P2 comprises
1 to 40% by weight, in particular from 5 to 30% by weight of repeating units (3), which are in particular repeating units of monomers M2a selected from the group consisting of C₁-C₂₂-alkyl terminated poly(ethylene glycol) (meth)acrylates;
25 to 85% by weight, in particular from 30 to 80% by weight of repeating units (4) which are in particular repeating units of monomers M2b selected from N-vinyl-2-pyrroldione and combinations of a N-vinyl-2-pyrroldione and a N—C₂-C₅-alkyl acrylamide,
5 to 50% by weight, in particular from 10 to 40% by weight of repeating units (5) of polymerized monomers M2c which methyl methacrylate,
   and optionally
0 to 10% by weight, in particular 0 to 8% by weight, e. g. 0.5 to 10% by weight, in particular 1 to 8% by weight of repeating units (6) of polymerized monomers M2d, which are in particular selected from acrylic acid, methacrylic acid and combinations thereof;
   wherein all values given in % by weight refer to the total weight of the polymer P2, i. e. the total weight of the repeating units (3), (4), (5) and optionally (6) which form the polymer P2.

The polymers P2 generally have a weight average molar weight Mw in the range of 1,000 to 100,000 g/mol, preferably in the range of 2,000 to 50,000 g/mol, more preferably in the range of 2,000 to 30,000 g/mol. The number average molar weight MN is generally in the range of 1,000 to 50,000 g/mol, preferably in the range of 1,000 to 15,000 g/mol, more particularly in the range of 2,000 to 8,000 g/mol, as determined by gel permeation chromatography.

The polymers P2 are obtainable by conventional polymerization processes, such as solution polymerization. The copolymers are preferably obtainable by polymerization of the monomers M2a, M2b and M2c and optionally M2d. Typically, the copolymer is a statistical polymer, in particular a linear statistical polymer of the repeating units (3), (4), (5) and optionally (6). For further details, reference is made to WO 2013/149856.

The formulation of the present invention further comprises at least one organic solvent as component C. The total amount of the component C is generally in the range of 50 to 84% by weight, in particular in the range of 60 to 78% by weight, based on the total weight of the formulation.

The solvent component C comprises at least 30% by weight, in particular at least 40% by weight, based on the total weight of the organic solvent, of at least one solvent C.1 which has a solubility in deionized water of at least 100 g/L, in particular at least 150 g/L or at least 200 g/L as determined at 20° C. and 1 bar. The solvent may also be completely miscible with deionized water at 20° C. and 1 bar. Preferably, the solvent C.1 is selected from the group of aprotic organic solvents.

The organic solvent C.1 of component C is preferably selected from the group consisting of
1-(C₁-C₆-alkyl)-2-pyrrolidones, such as N-methyl-2-pyrrolidone, N-ethyl-2-pyrrolidone, N-(n-propyl)-2-pyrrolidone, N-(n-butyl)-2-pyrrolidone, N-(tert-butyl)-2-pyrrolidone or N-(n-hexyl)-2-pyrrolidone, with preference given to 1-(n-butyl) 2-pyrrolidone and/or 1-(tert-butyl) 2-pyrrolidone;
N-(2-hydroxyethyl)-2-pyrrolidone;
C₃-C₆-lactones, such as gamma butyrolactone or gamma valerolactone;
dimethyl sulfoxide;
1,3-dimethylimidazolin-2-one;
   and mixtures thereof.

Preferably, the organic solvent C.1 of component C comprises at least one aprotic organic solvent which is selected from the group of 1-(C₂-C₆-alkyl)-2-pyrrolidones, such as N-ethyl-2-pyrrolidone, N-(n-propyl)-2-pyrrolidone, N-(n-butyl)-2-pyrrolidone, N-(tert-butyl)-2-pyrrolidone or N-(n-hexyl)-2-pyrrolidone, with preference given to 1-(n-butyl) 2-pyrrolidone and/or 1-(tert-butyl) 2-pyrrolidone, gamma butyrolactone and dimethyl sulfoxide.

Preferably, the organic solvent C.1 is a mixture of at least two different organic solvents C.1, e. g. a mixture of
C.1a at least one organic solvent selected from the group consisting of 1-(C₂-C₆-alkyl)-2-pyrrolidones, such as N-ethyl-2-pyrrolidone, N-(n-propyl)-2-pyrrolidone, N-(n-butyl)-2-pyrrolidone, N-(tert-butyl)-2-pyrrolidone or N-(n-hexyl)-2-pyrrolidone, with preference given to 1-(n-butyl) 2-pyrrolidone and/or 1-(tert-butyl) 2-pyrrolidone;
C.1b at least one organic solvent selected from the group consisting of gamma butyrolactone, dimethyl sulfoxide and 1,3-dimethylimidazolin-2-one:
   or a mixture of
C.1b′ a C₃-C₆-lactone, in particular gamma butyrolactone, and
C.1b″ at least one organic solvent selected from the group consisting of gamma butyrolactone, dimethyl sulfoxide and 1,3-dimethylimidazolin-2-one.

The amount of the solvents C.1 in the formulation, i. e. the total amount of any organic solvents of the group C.1 of solvents is generally in the range of 20 to 84% by weight, in particular in the range of 25 to 78% by weight, based on the total weight of the formulation.

The organic solvent C.1 may be the sole organic solvent of the solvent component C. However, the component C may also contain one or more organic solvents which have a solubility in deionized water of less than 100 g/L, in particular less than 80 g/L as determined at 20° C. and 1 bar. The amount of the solvent C.2 may be up to 70% in particular up to 60% by weight, based on the total weight of the solvent component C.

Examples of solvents C.2 include
C₂-C₁₀-alkyl esters of C₂-C₄-alkanoic acids, in particular C₂-C₁₀-alkyl esters of acetic acid or propionic acid, such as butyl acetate, n-hexyl acetate, n-octyl acetate, 2-octyl acetate and 2-ethylhexyl acetate;
N,N-di(C₁-C₄-alkyl) amides of C₆-C₂₀-alkanoic acids,
N—(C₇-C₁₄-alkyl) pyrrolidones,
C₄-C₁₀-alkyl lactates, such as butyl lactate, hexyl lactate and
C₁-C₄-alkylesters of C₆-C₂₀ fatty acids, in particular the methyl esters and the ethyl esters of C₆-C₂₀ fatty acids, also including methylated or ethylated plant oils
hydrocarbons,
acetophenone and mixtures thereof.

N,N-di(C₁-C₄-alkyl) amides of C₆-C₂₀-alkanoic acids can be described by the following formula (II)

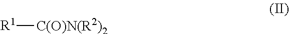

where
R¹ is C₅-C₁₉-alkyl, and R² may have identical or different meanings and is C₁-C₄-alkyl.

Preferred amides of the formula (II) are those, where R¹ is C₇-C₁₄-alkyl, and R² is methyl. Especially preferred amides of the formula (II) are those, where R¹ is C₇-C₁₂-alkyl, and R² is methyl. Mixtures of said amides are also possible. Examples include N,N-dimethyl octane amide, N,N-dimethyl decane amide, N,N-dimethyldodecane amide and mixtures of N,N-dimethyl octane amide and N,N-dimethyl decane amide.

Suitable hydrocarbon oils include aliphatic, cycloaliphatic and aromatic hydrocarbons, e. g. toluene, paraffin, tetrahydronaphthalene, alkylated naphthalenes. Also suitable are mineral oil fractions of medium to high boiling point, e.g. kerosene, diesel oil. Also suitable are alkyl-substituted aromatics, such as toluene, the xylenes, ethylbenzenes and benzenes with relatively long-chain alkyl radicals, e.g. Cg-Cio-dialkyl- and trialkylbenzenes (e.g. available under the name Solvesso® 100 from Exxon Mobile Europe or Aromatic 100 from Exxon Mobile USA), C₁₀-C₁₁-alkylbenzenes (e.g. available under the name Solvesso® 150 from Exxon Mobile Europe or Aromatic 150 from Exxon Mobile USA) and alkylnaphthalenes (e.g. available under the name Solvesso® 200 from Exxon Mobile Europe or Aromatic 200 from Exxon Mobile USA). Preferably, the hydrocarbon oil contains at least 50 wt %, more preferably at least 85 wt %, and in particular at least 95 wt % aliphatic and/or cycloaliphatic hydrocarbons. Preferably, the hydrocarbon contains not more than 10 wt %, preferably not more than 5 wt %, and in particular not more than 3 wt % aromatic hydrocarbons.

If present, the total amount of the solvent C.2 in the formulation is preferably in the range of 2 to 30% by weight, in particular in the range of 5 to 25% by weight, based on the total weight of the formulation.

The formulation of the present invention further contains at least one anionic surfactant D. Typically, the anionic surfactant has an anionic group selected from the group consisting of sulfonate, sulfate, phosphonate and phosphate. Suitable anionic surfactants include, but are not limited to, the following groups of surfactants.
D.1 alkylsulfates, in particular, C₈-C₁₈-alkyl sulfates,
D.2 alkylether sulfates, in particular those of the formula (III)

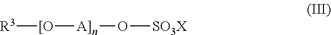

where R³ is linear or branched C₈-C₁₈-alkyl and A is CH₂CH₂ or CH₂CH(CH₃), n is in the range of 1 to 10 and X is a counter ion, such as Na, K, NH₄, mono-, di-, tri- or tetra-C₁-C₄-alkyl ammonium, mono-, di-, tri- or tetra-(hydroxyl-C₂-C₄-alkyl) ammonium, and the like;
D.3 aryl- and C₁-C₁₆-alkylarylsulfonates such as naphthylsulfonate, mono-, di- and tri-C₁-C₁₆-alkylnaphthylsulfonates such as dibutylnaphthylsulfonate, dodecyldiphenylether sulfonate, mono-, di- and tri-C₁-C₁₆-alkylphenylsulfonates such as cumylsulfonate, octylbenzene sulfonate, nonylbenzenesulfonate, dodecylbenzene sulfonate and tridecylbenzene sulfonate;
D.4 aryl ether sulfates, in particular aryl poly(C₂-C₄-alkylene oxide) ether sulfates, especially mono-, di- or tristyrylphenol poly(C₂-C₄-alkylene oxide) ether sulfates, which are also termed sulfated mono-, di and tristyrylphenol-C₂-C₄-alkoxylates, e.g. the sulfates of (poly)ethoxylated mono-, di- or tristyrylphenols and the sulfates of (poly)ethoxylated-co-propoxylated di- or tristyrylphenols;
D.5 aryl ether phosphates, in particular aryl poly(C₂-C₄-alkylene oxide) ether phosphates, e.g. the phosphate esters of (poly)ethoxylated di- or tristyrylphenols and the phosphate esters of (poly)ethoxylated-co-propoxylated di- or tristyrylphenols;
D.6 condensates of arylsulfonic acid, such as naphthalenesulfonic acid or phenolsulfonic acid, with formaldehyde and condensates of arylsulfonic acid, such as naphthalenesulfonic acid or phenolsulfonic acid, with formaldehyde and urea;

The anionic surfactants are usually present in the formulation of the invention as their salts, in particular the ammonium salts, the alkaline metal salts, such as the sodium or potassium salt, and the earth alkaline metal salts, in particular the calcium salts. Preferred anionic surfactants D are those of the groups D.4 and D.5, in particular the aryl poly(C₂-C₄-alkylene oxide) ether sulfates the and aryl poly(C₂-C₄-alkylene oxide) ether phosphates, more preferably mono-, di- or tristyrylphenol poly(C₂-C₄-alkylene oxide) ether sulfates and phosphates, more preferably the mono-, di- or tristyrylphenol poly(C₂-C₄-alkylene oxide) ether sulfates, and especially the sulfates of (poly)ethoxylated di- or tristyrylphenols, where the aforementioned compounds generally have 5 to 70, in particular 10 to 60 or 15 to 50 C₂-C₄-alkylene oxide repeating units, e.g. ethylenoxide repeating units.

In the group of surfactants D.3 preference is given to mono- or di-C₄-C₈-alkyl-naphthalene sulfonic acid and mono- or di-C₄-C₁₆-alkylbenzesulfonic acid and the ammonium salts, the alkaline metal salts, such as the sodium or potassium salt, and the earth alkaline metal salts, in particular the calcium salts thereof. Particularly suitable examples are Morwet® EFW (Akzo Nobel), and the like.

In the group of surfactants D.4 preference is given to the ammonium salts, alkaline metal salts and earth alkaline metal salts of aryl poly(C₂-C₄-alkylene oxide) ether sulfates, in particular sulfates of mono-, di and tristyrylphenol-C₂-C₄-alkoxylates especially the sulfates of (poly)ethoxylated mono-di- or tristyrylphenols, in particular of those having from 5 to 70, in particular 10 to 60 or 15 to 50 C₂-C₄-alkylene oxide repeating units, e. g. ethylenoxide repeating units. Particularly suitable examples of sulfates of (poly)ethoxylated di- or tristyrylphenols are Soprophor® 4D384 of Solvay and the like.

In the group of surfactants D.5 preference is given to the ammonium salts and alkaline metal salts of phosphates of mono-, di and tristyrylphenol-C₂-C₄-alkoxylates especially the phosphates of (poly)ethoxylated mono-di- or tristyrylphenols, in particular of those having from 5 to 70, in particular 10 to 60 or 15 to 50 C₂-C₄-alkylene oxide repeating units, e. g. ethylenoxide repeating units.

The total amount of the components A, B, C and D in the formulations of the present invention is typically at least 80% by weight, in particular at least 85% by weight and especially at least 90% by weight or at least 95% by weight and may be as high as 100% by weight, based on the total weight of the formulation.

Besides the aforementioned components A, B, C and D the composition may contain one or more non-ionic emulsifiers as a component E. Suitable non-ionic emulsifiers include but are not limited to
homo- or copolymers of C₂-C₃-alkyleneoxides, in particular EO homopolymers, PO homopolymers or EO/PO copolymers, such as polyoxyethylene-polyoxypropylene-blockcopolymers;
polyoxy-C₂-C₃-alkylene C₈-C₂₂-alkyl ethers, in particular polyethoxylates and poly-ethoxylates-co-propoxylates of linear or branched C₈-C₂₂-alkanols, such as polyethoxylated lauryl alcohol, polyethoxylated isotridecanol, polyethoxylated cetyl alcohol, polyethoxylated stearyl alcohol, polyethoxylated-co-propoxylated lauryl alcohol, polyethoxylated-co-propoxylated isotridecanol, polyethoxylated-co-propoxylated cetyl alcohol, polyethoxylated-co-propoxylated stearyl alcohol, and mixtures thereof;
polyoxy-C₂-C₃-alkylene aryl ethers and polyoxy-C₂-C₃-alkylene C₁-C₁₆-alkylaryl ethers, such as polyoxy-C₂-C₃-alkylene C₈-C₂₂-alkylbenzene ethers, in particular polyethoxylates of C₁-C₁₆-alkylphenoles and polyethoxylate-co-propoxylates of C₁-C₁₆-alkylphenoles, such as polyethoxylates and polyethoxylate-co-propoxylates of nonylphenol, decylphenol, isodecylphenol, dodecylphenol or isotridecylphenol,
polyoxy-C₂-C₃-alkylene mono-, di- or tristyryl phenyl ethers, in particular polyethoxylates of mono-, di-und tristyrylphenoles; and the formaldehyde condensates thereof and the esters thereof, e.g. the acetates;
C₆-C₂₂-alkylglucosides and C₆-C₂₂-alkyl polyglucosides;
polyethoxylates of C₆-C₂₂-alkylglucosides and polyethoxylates of C₆-C₂₂-alkyl polyglucosides;
polyethoxylates of fatty acids and polyethoxylates of hydroxyl fatty acids;
partial esters of polyols with C₆-C₂₂-alkanoic acids, in particular mono- and diesters of glycerine and mono-, di- and triesters of sorbitan, such as glycerine monostearate, sorbitanmonooleat, sorbitantristearat;
polyethoxylates of partial esters of polyols with C₆-C₂₂-alkanoic acids, in particular polyethoxylates of mono- and diesters of glycerine and polyethoxylates of mono-, di- and triesters of sorbitan, such as polyethoxylates of glycerine monostearate, polyethoxylates of sorbitanmonooleat, polyethoxylates of sorbitanmonostearat and polyethoxylates of sorbitantristearat;
polyethoxylates of vegetable oils or animal fats such as corn oil ethoxylate, castor oil ethoxylate, tallow oil ethoxylate;
polyethoxylates of fatty amines, fatty amides or of fatty acid diethanolamides.

The term polyoxy-C₂-C₃-alkylene ether refers to polyether radicals derived from ethylene oxide (EO) or propylene oxide (PO). The term polyethoxylate refers to a polyether radical derived from ethylene oxide. Likewise, the term polyoxyethylene-co-polyoxypropylene refers to a polyether radical derived from a mixture of ethylene oxide and propylene oxide. The number of repeating units in the polyether radicals will generally vary from 1 to 50, frequently from 2 to 40 and in particular from 2 to 30.

Amongst the aforementioned non-ionic surfactants preference is given to polyoxy-C₂-C₃-alkylene C₈-C₂₂-alkyl ethers, in particular polyethoxylates and poly-ethoxylates-co-propoxylates of linear or branched C₈-C₂₂-alkanols, such as polyethoxylated lauryl alcohol, polyethoxylated isotridecanol, polyethoxylated cetyl alcohol, polyethoxylated stearyl alcohol, polyethoxylated-co-propoxylated lauryl alcohol, polyethoxylated-co-propoxylated isotridecanol, polyethoxylated-co-propoxylated cetyl alcohol, polyethoxylated-co-propoxylated stearyl alcohol, and mixtures thereof.

In particular, the liquid formulations of the present invention may contain one or more of the aforementioned non-ionic surfactants in an amount of 0.1 to 10% by weight, in particular in an amount of 0.2 to 80% by weight, especially in an amount of 0.5 to 5% by weight, based on the total weight of the liquid formulation.

Besides the aforementioned components A, B, C, D and E, the formulations of the present invention may contain conventional additives which may usually contained in liquid formulations of organic pesticide compounds. These additives include, but are not limited to anti-foam agents, dyes, pigments and preservatives to prevent microbial spoiling. The total amount of these additives will generally not exceed 5% by weight.

Antifoam agents suitable for the formulations according to the invention are, for example, silicone emulsions (such as, for example, Silicone SRE-PFL from Wacker or Rhodorsil® from Bluestar Silicones), long-chain alcohols, fatty acids, organofluorine compounds and mixtures thereof. The amount of such antifoam may depend on the type of antifoam and, if present, is typically in the range of 0.01 to 0.5 wt.-%, based on the total weight of the formulation.

Suitable preservatives to prevent microbial spoiling of the compositions of the invention include formaldehyde, alkyl esters of p-hydroxybenzoic acid, sodium benzoate, 2-bromo-2-nitropropane-1,3-diol, o-phenylphenol, thiazolinones, such as 1,2-benzisothiazol-3 (2H)-one, 5-chloro-2-methyl-4-isothiazolinone (CIT), methylisothiazolinon (MIT) pentachlorophenol, 2,4-dichlorobenzyl alcohol and mixtures thereof. Commercially available preservatives that are based on isothiazolinones are for example marketed under the trademarks Proxel® (Arch Chemical), Acticide® grades, such as MV, MBS and B20 (Thor Chemie) and Kathon® MK (Rohm & Haas). 2-bromo-2-nitropropane-1,3-diol is commercially available as Acticide® L30.

The formulation of the present invention may contain small amounts of water. Preferably, the amount of water does not exceed 15% by weight of the formulation and is in particular at most 10% by weight or at most 5% by weight.

In particular, the formulation of the present invention is in the form of an emulsifiable concentrate or a soluble liquid concentrate. An emulsifiable concentrate will form an oil-in-water-emulsion upon dilution with water, while a soluble liquid concentrate will form a dispersion of the PPO inhibitor upon dilution with water. Thus and emulsifiable concentrate will typically contain at least one solvent C.2 in an amount of at least 10% or at least 20% by weight of the formulation while the soluble liquid concentrate will not contain any solvent C.2 or only smaller amounts of solvents C.2.

The formulations of the present invention can be simply prepared by mixing the components A), B, C) and D), whereby a solution of the component A in the mixture of components B), C) and D) is obtained. For example, it may be possible to first dissolve the component A) in the component C or in the solvent C.1 and mix the remaining components with the solution.

The formulation of the present invention are suitable for controlling undesired plant growth, in particular undesired plant growth in crop. For this, the aqueous formulation is applied to the undesired plants or to an area where the undesired plants will grow.

The formulation of the invention can be applied in numerous crops. The crops include in particular field corn, including field corn grown for producing grain, seed or silage, popcorn, sweet corn, soybean, chickpea, edible pea, field pea, lentils, including green and red type, perennial grasses, in particular when grown for seed production, alfalfa, in particular in established stands of dormant alfalfa, in cereals, legume and oilseed cover crops. The formulations are active against broad-leaved weeds and grass weeds without inflicting substantial damage to the crop plants. For this, the formulations and the combinations of the invention are preferably applied pre-emergently, i. e. before the undesired plants emerge. Pre-emergent application in crops may be carried out shortly before or shortly after the crop has been planted but preferably before the crop plants emerge.

The formulation of the invention can be applied in crops which have been modified by mutagenesis or genetic engineering in order to provide a new trait to a plant or to modify an already present trait. Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect. Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include in particular herbicide tolerance, insect resistance, increased yield and tolerance to abiotic conditions, like drought.

Examples of genetically modified crops in which the formulations and combinations can be used include in particular corn and soybean: Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS-81419-2, GU262, SYHTØH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GHB119, GHB614, LLCotton25, T303-3 and T304-40.

The formulations of the invention provide a very good control of vegetation during the fallow period, i. e. the period following harvest and before the following crop is planted.

The formulations of the invention provide a very good control of vegetation also in non-crop areas, especially at high application rates.

The formulations of the invention provide a very good control of the following plants, including
broadleaf weeds, such as Amaranth, Palmer (Amaranthus palmeri), Amaranth, Powell (Amaranthus powelli), Bedstraw, catchweed (Galium aparine), Beggarticks, hairy (Bidens pilosa), Beggarweed, Florida (Desmodium tortuosum), Bindweed, field (Convolvulus arvensis), Buckwheat, wild (Polygonum convolvulus), Buffalobur (Solanum rostratum) C. Burcucumber (Sicyos angulatus) S, Canola, volunteer (rapeseed), all types (Brassica spp.), Carpetweed (Mollugo verticillata), Chamomile, mayweed (Anthemis cotula), Chickweed, common (Stellaria media), Cocklebur, common (Xanthium strumarium), Copperleaf, Virginia (Acalypha virginica), Cotton, volunteer (Gossypium hirsutum), Cowcockle (Vaccaria pyramidata), Dandelion (Taraxacum officinale), Devil's-claw (Proboscidea louisiana), Eclipta (Eclipta prostrata), Eveningprimrose, cutleaf (Oenothera laciniata), Galinsoga, smallflower (Galinsoga parviflora), Falseflax, smallseed (Camelina macrocarpa), Filaree, redstem (Erodium cicutarium), Fleabane, hairy (Conyza bonariensis), Flixweed (Descurainia sophia), Groundcherry, cutleaf (Physalis angulate), Groundsel, common (Senecio vulgaris), Hawksbeard, narrowleaf (Crepis tectorum), Hemlock, poison (Conium maculatum), Henbit (Lamium amplexicaule), Horseweed (marestail) (Conyza canadensis), Jimsonweed (Datura stramonium), Knotweed, prostrate (Polygonum aviculare), Kochia (Kochia scoparia), Ladysthumb (Polygonum persicaria), Lambsquarters, common (Chenopodium album), Lambsquarters, narrowleaf (Chenopodium pratericola), Lettuce, prickly (Lactuca serriola), Mallow, common (Malva neglecta), Mallow, little (cheeseweed) (Malva parviflora), Mallow, Venice (Hibiscus trionum), Marestail (horseweed) (Conyza canadensis), Morningglory, entireleaf (Ipomoea hederacea var. integriuscula), Morningglory, ivyleaf (Ipomoea hederacea), Morningglory, palmleaf (Ipomoea wrightii), Morningglory, pitted (Ipomoea lacunose), Morningglory, tall (Ipomoea purpurea), Mustard, black (Brassica nigra), Mustard, tumble (Sisymbrium altissimum), Mustard, wild (Sinapis arvensis), Nettle, burning (Urtica urens), Nightshade, black (Solanum nigrum), Nightshade, cutleaf (Solanum triflorum), Nightshade, Eastern black (Solanum ptycanthum), Nightshade, hairy (Solanum sarrachoides), Parthenium (Parthenium hysterophorus), Pennycress, field (Thlaspi arvense), Pigweed, prostrate (Amaranthus blitoides), Pigweed, redroot (Amaranthus retroflexus), Pigweed, smooth (Amaranthus hybridus), Pigweed, tumble (Amaranthus albus), Puncturevine (Tribulus terrestris), Purslane, common (Portulaca oleracea), Pusley, Florida (Richardia scabra), Ragweed, common (Ambrosia artemisiifolia), Ragweed, giant (Ambrosia trifida), Rocket, London (Sisymbrium irio), Sesbania, hemp (Sesbania exaltata), Shepherds-purse (Capsella bursa-pastoris), Sida, prickly (Sida spinosa), Smartweed, Pennsylvania (Polygonum pensylvanicum), Sowthistle, annual (Sonchus arvensis), Spurge, nodding (Chamaesyce nutans), Spurge, spotted (Chamaesyce maculate), Starbur, bristly (Acanthospermum hispidum), Sunflower, common (Helianthus annuus), Tansymustard, pinnate (Descurainia pinnata), Texasweed (Caperonia palustris), Thistle, Canada (Cirsium arvense), Thistle, Russian (Salsola kali), Velvetleaf (Abutilon theophrast), Waterhemp (Amaranthus tuberculatus) and Willowweed (Epilobium adenocaulon);

Annual grass weeds, such as Barley, hare (Hordeum murinum spp. leporinum); Barnyardgrass (Echinochloa crus-galli), Bluegrass, annual (Poa annua), Bluegrass, roughstalk (Poa trivialis), Brome, California (Bromus carinatus), Brome, downy (Bromus tectorum), Brome, Japanese (Bromus japonicus), Canarygrass (Phalaris canariensis), Cheat (Bromus secalinus), Crabgrass, large (Digitaria sanguinalis), Crabgrass, smooth (Digitaria ischaemum), Crowfootgrass (Dactyloctenium aegyptium), Cupgrass, Southwestern (Eriochloa gracilis), Cupgrass, woolly (Eriochloa villosa), Fescue, rattail (Vulpia myuros), Foxtail, giant (Setaria faberi), Foxtail, green (Setaria viridis), Foxtail, yellow (Setaria pumila), Goosegrass (Eleusine indica), Johnsongrass (seedling) (Sorghum halepense), Millet, Texas (Urochloa texana), Millet, wild proso (Panicum miliaceum), Oat, wild (Avena fatua), Panicum, fall (Panicum dichotomiflorum), Panicum, Texas (Panicum texanum), Rice, red (Oryza sativa), Ryegrass, Italian (Lolium multiflorum), Ryegrass, rigid (Lolium rigidum), Sandbur (Cenchrus spp.), Shattercane (Sorghum bicolor), Signalgrass, broadleaf (Brachiaria platyphylla), Witchgrass (Panicum capillare), Flatsedge, rice (Cyperus iria) and Nutsedge, yellow (Cyperus esculentus).

The application of the formulation of the invention may vary depending on the rate may depend on the kind of ground to which the formulation is applied is typically in the range of 0.02 to 1.5 kg/h, in particular in the range of 0.03 to 1 kg/ha.

The application rates of the PPO inhibitor is typically in the range of 10 to 300 g/ha, in particular in the range of 15 to 200 g/ha.

The formulations of the present invention may be applied preplant, preemergence, or as burndown application, in particular in the fall. Preplant application may be done to the surface or by incorporating the formulation or the individual herbicides of the combination into the ground.

Preplant surface application is typically carried out by applying a uniform broadcast to the soil surface. Preplant surface application is usually carried out within 30 days of planting and before crop emergence. For preplant incorporated (PPI) application the formulation or the individual herbicides of the combination are usually incorporated into the upper soil surface, e. g. into a depth of 2 to 6 cm, preferably within 14 days of planting. Incorporation may be carried out by shallow incorporation, including a field cultivator, harrow, rolling cultivator, or finishing disc.

The application of the formulation of the invention may be carried out using water or a fluid nitrogen fertilizer as a spray carrier. For this, the respective formulations are diluted with water or the liquid nitrogen fertilizer to obtain a liquid spray liquor. Frequently, the amount of water used is at least 20 L/ha, in particular at least 25 L/ha and may be as high as 1000 L/ha.

The spray liquors can be applied in conventional manner by using techniques as skilled person is familiar with. Suitable techniques include spraying, atomizing, dusting, spreading or watering. The type of application depends on the intended purpose in a well-known manner; in any case, they should ensure the finest possible distribution of the active ingredients according to the invention.

It is also possible to apply the formulations of the present invention in the form of fertilizer granules which have been impregnated with the formulations of the present invention.

To achieve a broader activity spectrum it may be possible to co-apply the formulation of the present invention with a further herbicide.

The formulation of the present invention may be applied together with an adjuvant as action improver. A particular preferred adjuvant is described in WO 00/53014 and in WO 2010/037734. Said adjuvant is a combination of a C₁-C₅-alkyl C₅-C₂₂-alkanoate, a C₁₀-C₂₀-carboxylic acid, a partial phosphoric or sulfuric acid ester of a monohydroxy-functional polyalkyl ether and an alkyl polyoxyalkylene polyether. Preferred C₁-C₅-alkyl C₅-C₂₂-alkanoates are methyl oleate, methyl palmitate and ethyl oleate and mixtures thereof. Specifically, the C₁-C₅-alkyl C₅-C₂₂-alkanoate comprises at least 70% by weight of methyl oleate or of a mixture of methyl oleate and methyl palmitate. Such action improver systems are commercially available under the name DASH®, e.g. DASH® HC, from BASF Corporation, USA. Further action improvers include but are not limited to those adjuvants conventionally used in combination with glyphosate, such as non-ionic surfactants (NIS), ammonium sulfate, alkyl sulfates of C₆₋₁₈ alkanols such as sodium dodecyl sulfate, alkyl ether sulfates of C₆₋₁₈ alkanols, methylated soybean oil (MSO) and crop oil concentrate (COC).

The following examples are intended to further illustrate the present invention without limiting its scope in any way.

In the examples, the following abbreviations are used:
1,3-DMI 1,3-dimethylimidazolin-2-one
2-Ehex 2-ethylhexyl
DMSO dimethyl sulfoxide
GBLO gamma butyrolactone
Mn number average molecular weight
NBL N-(n-butyl)-2-pyrrolidone
w week

### I. Analytics:

Viscosity was determined by Brookfield method (using spindle no. 2 at 30 rpm) and with an Anton Paar Rheometer.

The herbicide content was analysed by common HPLC methods.

Optical evaluation was carried out visually.

### II. Ingredients:

Polymer 1: Graftcopolymer of 13 wt. % of polyethylene glycol (Mn 6000), 57 wt. % of N-vinyl-2-caprolactam and 30 wt. % of vinyl acetate and having a K-value determined in 1% ethanol of 35, prepared by analogy to the protocol of example 6 of WO 2007/051743
Polymer 2: Commercial Copolymer of N-vinyl-2-pyrrolidone and vinyl acetate in a weight ratio of 60:40 (Luviskol® VA 64 of BASF SE)
Polymer 3: Copolymer D of WO 2013/149856 obtained by copolymerization of 38 wt. % of N-vinyl-2-pyrrolidone, 29 wt. % of methyl methacrylate, 20 wt % of tert.-butylacrylate, 10 wt % of C₁₆/C₁₈ alkyl terminated polyethyleneglykol methacrylate having 25 ethyleneglykol units (number average) and 3 wt. % of methacrylic acid in the form of a 50 wt. % solution in N,N-dimethyldecanamide;
Surfactant 1: polyethylene glycol mono (tristyryl phenyl) ether sulfate ammonium salt-Soprophor® 4D/384 (Solvay);
Surfactant 2: polyethoxylated-co-propoxylated C₁₂-fatty alkanol having an HLB of 11.7;
Saflufenacil: Production grade, purity>97.5%;
Trifludimoxazin: Production grade, purity>97.5%;
Fatty acid diamide; Mixture of N,N-dimethyl amides of C₈/C₁₀ fatty acid mixture (Agnique 810 of BASF SE)

### III. Preparation of the Compositions of the Invention

The compositions of the present invention were prepared by mixing the ingredients of the respective components as indicated in the following tables 1 to 3 by stirring the mixture in a glass beaker equipped with a magnetic stirring bar at ambient temperature until the mixture was virtually homogeneous. Examples 1 to 10 are merely for demonstration that the PPO inhibitor saflufenacil can be stably formulated in the respective mixture of components B and C.

The thus obtained formulations were visually inspected and stored at 54° C. for two weeks. The content of the PPO inhibitor was determined before storage and after storage as described above to determine whether the PPO inhibitor decomposes during storage.

TABLE 1a

| | Example | | | | | |
|---|---|---|---|---|---|---|
| Ingredients (wt. %) | 1 | 2 | 3 | 4 | 5 | 6 |
| Saflufenacil | 30 | 30 | 30 | 30 | 30 | 30 |
| Polymer 1 | 5 | 5 | 5 | 0 | 0 | 0 |
| Polymer 2 | 0 | 0 | 0 | 5 | 5 | 5 |
| NBP | 29.5 | 29.5 | 29.5 | 29.5 | 29.5 | 29.5 |
| n-butyl actetate | 12 | 0 | 0 | 12 | 0 | 0 |
| n-hexyl acetate | 0 | 12 | 0 | 0 | 12 | 0 |
| 2-Ehex actetate | 0 | 0 | 12 | 0 | 0 | 12 |
| GBLO | 23.5 | 23.5 | 23.5 | 23.5 | 23.5 | 23.5 |
| solubility | clear, light | clear, light | clear, light | clear, light | clear, light | clear, light |
| | brown | brown | brown, changed | brown | brown | brown |
| | | | to slightly | | | |
| | | | turbid | | | |
| visual 2 w 54° C. ¹⁾ | unchanged | unchanged | unchanged | unchanged | unchanged | unchanged |
| content initial [%] | 29.46 | 29,09 | 28.98 | 29.02 | 29.39 | 29.06 |
| content [%] 2 w 54° C. ¹⁾ | 29.21/99.15% | 29.31/100% | 29.01/100% | 28.75/99.07% | 29.22/99.42% | 29.15/100% |

¹⁾ after storage for 2 weeks at 54° C.

TABLE 1b

| Example | 7 | 8 | 9 | 10 | 11 |
|---|---|---|---|---|---|
| Ingredients (wt. %) | | | | | |
| Saflufenacil | 30 | 30 | 30 | 30 | 30 |
| Polymer 1 | 5 | 5 | 5 | 0 | 0 |
| NBP | 30 | 20 | 30 | 20 | 29.5 |
| 1,3-DMI | 0 | 0 | 35 | 45 | 0 |
| Ethyl acetate | 0 | 0 | 0 | 0 | 12 |
| GBLO | 35 | 45 | 0 | 0 | 23.5 |
| solubility | clear, light | clear, light | clear, light | clear, light | clear, light |
| | brown | brown | brown | brown | brown |
| visual 2 w 54° C. ¹⁾ | | | | | |
| content initial [%] | | | | | |
| content [%] 2 w 54° C. ¹⁾ | | | | | |

¹⁾ after storage for 2 weeks at 54° C.

TABLE 1c

| | Example | | | | | |
|---|---|---|---|---|---|---|
| Ingredients (wt. %) | 12 | 13 | 14 | 15 | 16 | 17 |
| Trifludimoxazin | 30 | 30 | 30 | 30 | 30 | 30 |
| Polymer 1 | 5 | 5 | 5 | 0 | 0 | 0 |
| Polymer 2 | 0 | 0 | 0 | 5 | 5 | 5 |
| NBP | 29.5 | 29.5 | 29.5 | 29.5 | 29.5 | 29.5 |
| n-butyl actetate | 12 | 0 | 0 | 12 | 0 | 0 |
| n-hexyl acetate | 0 | 12 | 0 | 0 | 12 | 0 |
| 2-Ehex actetate | 0 | 0 | 12 | 0 | 0 | 12 |
| GBLO | 23.5 | 23.5 | 23.5 | 23.5 | 23.5 | 23.5 |
| solubility | clear, dark | clear, dark | clear, dark | clear, | clear, dark | clear, dark |
| | brown | brown | brown, | dark | brown | brown |
| visual 2 w 54° C. ¹⁾ | unchanged | unchanged | unchanged | unchanged | unchanged | unchanged |
| content initial [%] | 30.15 | 30.14 | 29.73 | 30.19 | 30.14 | 30.12 |
| content [%] 2 w 54° C. ¹⁾ | 30.0/99.5% | 29.7/98.6% | 100% | 29.8/98.6% | 29.8/98.7% | 30.0/99.5% |

¹⁾ after storage for 2 weeks at 54° C.

TABLE 2

| Example | 18 | 19 | 20 | C1 | C2 |
|---|---|---|---|---|---|
| Ingredients (wt. %) | | | | | |
| Saflufenacil | 25.56 | 25.56 | 25.56 | 30.67 | 20.45 |
| Surfactant 1 | 20 | 20 | 20 | 15 | 20 |
| Polymer 2 | 5 | 2.5 | 0 | 0 | 0 |
| Polymer 3 | 0 | 0 | 2.5 | 0 | 0 |
| DMSO | 25 | 25 | 25 | 27.5 | 25 |
| 2-ethylhexyl actetate | 15 | 15 | 15 | 15 | 0 |
| NBP | 0 | 0 | 0 | 0 | 15 |
| Fatty acid diamide | 0 | 0 | 0 | 0 | ad.100% |
| | | | | | (19.55) |
| GBLO | ad.100% | ad. 100% | ad.100% | ad. 100% | 0 |
| | (9.44%) | (11.94%) | (11.94%) | (11.83%) | |
| solubility | | | | | |
| visual 2 w 54° C. ¹⁾ | | | | | |
| content initial [%] | | | | | |
| content [%] 2 w 54° C. ¹⁾ | | | | | |

¹⁾ after storage for 2 weeks at 54° C.

TABLE 3

| | Example | | | | | |
|---|---|---|---|---|---|---|
| Ingredients (wt. %) | 21 | 22 | 23 | 24 | 25 | 26 |
| Saflufenacil | 25 | 25 | 25 | 25 | 25 | 25 |
| Surfactant 1 | 18 | 18 | 18 | 22.5 | 22.5 | 22.5 |
| Surfactant 2 | 2 | 2 | 2 | 2.5 | 2.5 | 2.5 |
| Polymer 2 | 5 | 5 | 5 | 5 | 5 | 5 |
| DMSO | 40 | 30 | 20 | 35 | 25 | 15 |
| GBLO | 10 | 20 | 30 | 10 | 20 | 30 |
| solubility | | | | | | |
| visual 2 w 54° C. ¹⁾ | | | | | | |
| content initial [%] | | | | | | |
| content [%] 2 w 54° C. ¹⁾ | | | | | | |

¹⁾ after storage for 2 weeks at 54° C.

For assessing the uptake of the PPO inhibitor by plants the formulations of examples 19, 20 and comparative examples C1 and C2 were diluted with water containing a small amount of methylated seed oil adjuvant. The thus obtained aqueous dilution was sprayed to plants of Amaranthus retroflexus. After 5 h the plants were washed with deionized water and the washed plants were extracted with a polar organic solvent. Both the extract and the wash water were analyzed by HPLC with respect to the concentration of saflufenacil. The uptake of the PPO inhibitor (saflufenacil) was assessed by the relative amounts of saflufenacil contained in the plants with respect to the total amount of saflufenacil found in the plants and the wash water.

In this experiment the example 19 and 20 resulted in an uptake of saflufenacil of 61% and 36% while comparative examples C₁ and C₂ resulted in an uptake of saflufenacil of about 25%.

1. A liquid agricultural formulation comprising
a) at least one herbicide of PPO-inhibitors as a component A,
b) at least one polymer as component B which is selected from the group consisting of
b.1 a polymer P1 comprising
i) polymerized units (1) selected from the group consisting of poly-C₂-C₄-alkyleneoxides, polymerized N-vinyl lactams, and combinations thereof;
ii) polymerized units (2) selected from the group consisting of polymerized vinylesters of C₂-C₃-alkanoic acids,
where a total amount of polymerized units (1) and (2) is at least 90% by weight, based on a total weight of the polymer P1;
b.2 a polymer P2 comprising
iii) repeating units (3) of one or more polymerized monomers M2a selected from the group consisting of monoethylenically unsaturated monomers having a poly-C₂-C₄-alkyleneoxide group;
iv) repeating units (4) of one or more polymerized monomers M2b selected from the group consisting polymerized N-vinyl lactams, polymerized N—C₁-C₆-alkyl acrylamides, and polymerized N—C₁-C₆-alkyl methacrylamides; and
v) repeating units (5) of one or more polymerized monomers M2c selected from the group consisting of polymerized C₁-C₈-alkylesters of acrylic acid and polymerized C₁-C₈-alkylesters of methacrylic acid;
where a total amount of polymerized units (3), (4), and (5) is at least 90% by weight, based on a total weight of the polymer P2;
c) at least one organic solvent as component C, which comprises at least 30% by weight, based on a total weight of the organic solvent, of at least one solvent C.1 which has a solubility in deionized water of at least 100 g/L as determined at 20° C. and 1 bar, and optionally up to 70% by weight of one or more solvent C.2, which has a solubility in deionized water of less than 100 g/L as determined at 20° C. and 1 bar;
d) at least one anionic surfactant as a component D,
where the component A is dissolved in a mixture comprising the components B, C and D.

2. The formulation according to claim 1, wherein the component A is selected from the group consisting of saflufenacil, trifludimoxazin, and mixtures thereof.

3. The formulation according to claim 1, wherein a concentration of the component A in the formulation is in a range of 20 to 60% by weight, based on the total weight of the formulation.

4. The formulation according to claim 1, wherein the component B is a polymer P1, which is selected from the group consisting of
b.1.1 a non-ionic graft copolymer P1.1, having a poly-C₂-C₄-alkyleneoxide backbone and polymeric side chains grafted onto the polymeric backbone, where the polymeric side chains consist of polymerized nonionic monoethylenically unsaturated monomers M1 comprising a monomer M1a which is selected from vinylesters of C₂-C₃-alkanoic acids and optionally a monomer M1b which is selected from N-vinyl lactams; and
b. 1.2 a non-ionic linear copolymer P1.2 of polymerized nonionic monoethylenically unsaturated monomers M comprising a monomer M1a which is selected from vinylesters of C₂-C₃-alkanoic acids and at least one monomer M1b which is selected from N-vinyl lactams.

5. The formulation according to claim 4, wherein the polymer P1 is
(i) a non-ionic graft copolymer P1.1 comprising from 5 to 50% by weight of the poly-C₂-C₄-alkyleneoxide backbone, from 10 to 50% by weight of polymerized vinylesters of C₂-C₃-alkanoic acids, and from 30 to 80% by weight of polymerized N-vinyl lactams, wherein all values given in % by weight refer to a total weight of the polymer P1.1; or
(ii) a non-ionic graft copolymer P1.1 comprising from 30 to 80% by weight of the poly-C₂-C₄-alkyleneoxide backbone and from 20 to 70% by weight of polymerized vinylesters of C₂-C₃-alkanoic acids, wherein all values given in % by weight refer to the total weight of the polymer P1;
wherein the poly-C₂-C₄-alkyleneoxide backbone is a polyethyleneoxide backbone having a number average weight, as determined by gel permeation chromatography, in a range of 1,000 to 100,000 Dalton.

6. The formulation according to claim 4, wherein the polymer P1 is a non-ionic linear copolymer P1.2 comprising from 30 to 80% by weight of polymerized N-vinyl lactams and from 20 to 70% by weight of polymerized vinylesters of C₂-C₃-alkanoic acids, wherein all values given in % by weight refer to the total weight of the polymer P1.2.

7. The formulation according to claim 1, wherein the component B is a polymer P2, wherein the polymer P2 is a non-ionic copolymer P2.1 comprising from 1 to 40% by weight of repeating units (3), 25 to 85% by weight of repeating units (4), and from 5 to 50% by weight of repeating units (5), wherein all values given in % by weight refer to the total weight of the polymer P2.

8. The formulation according to claim 1, wherein the total amount of the component B is in a range of 1 to 10% by weight, based on the total weight of the formulation.

9. The formulation according to claim 1, wherein the organic solvent C.1 of component C is selected from the group consisting of 1-(C₁-C₆-alkyl) 2-pyrrolidones, 1-(2-hydroxylethyl)-2-pyrrolidone, C₃-C₆-lactones, dimethyl sulfoxide, 1,3 dimethylimidazolin-2-one, and mixtures thereof.

10. The formulation according to claim 1, wherein an amount of the solvent C.1 is in a range of 20 to 84% by weight, based on the total weight of the formulation.

11. The formulation according to claim 1, wherein the solvent C comprises an aprotic organic solvent C.2 which has a solubility in deionized water at 25° C. and 1 bar of less than 100 g/L.

12. The formulation according to claim 11, wherein the organic solvent C.2 is selected from the group consisting of C₂-C₁₀-alkyl esters of C₂-C₄-alkanoic acids, N,N-di(C₁-C₄-alkyl) amides of C₆-C₂₀-alkanoic acids, N—(C₇-C₁₄-alkyl) pyrrolidones, C₄-C₁₀-alkyl lactates, C₁-C₄-alkylesters of C₆-C₂₀ fatty acids, hydrocarbons, acetophenone, and mixtures thereof.

13. The formulation according to claim 11, wherein a total amount of the solvent C.2 is in a range of 2 to 30% by weight, based on the total weight of the formulation.

14. The formulation according to claim 1, wherein a total amount of the component C is in a range of 50 to 84% by weight, based on the total weight of the formulation.

15. The formulation according to claim 1, where the at least one anionic surfactant of the component D comprises a surfactant selected from the group of sulfated mono-, di-, and tristyrylphenol-C₂-C₄-alkoxylates.

16. The formulation according to claim 1 comprising,
a) 10 to 60% by weight, based on the total weight of the formulation, at least one herbicide of the group of PPO-inhibitors as a component A, which is selected from the group consisting of saflufenacil, trifludimoxazin, and mixtures thereof;
b) 1 to 10% by weight, based on the total weight of the formulation of at least one polymer as component B which is selected from the group consisting of
b.1.1 a non-ionic graft copolymer P1.1, having a poly-C₂-C₄-alkyleneoxide backbone and polymeric side chains grafted onto the polymeric backbone, where the polymeric side chains consist of polymerized nonionic monoethylenically unsaturated monomers M1 comprising a monomer M1a which is selected from vinylesters of C₂-C₃-alkanoic acids, and optionally a monomer M1b which is selected from N-vinyl lactams;
b. 1.2 a non-ionic linear copolymer P1.2 of polymerized nonionic monoethylenically unsaturated monomers M comprising a monomer M1a which is selected from vinylesters of C₂-C₃-alkanoic acids and at least one monomer M1b which is selected from N-vinyl lactams;
b.2 a copolymer P2.1 comprising
1 to 40% by weight of repeating units (3) of one or more polymerized monomers M2a selected from the group consisting of monoethylenically unsaturated monomers having a poly-C₂-C₄-alkyleneoxide group;
25 to 85% by weight of repeating units (4) of one or more polymerized monomers M2b selected from the group consisting polymerized N-vinyl lactams, polymerized N—C₁-C₆-alkyl acrylamides, and polymerized N—C₁-C₆-alkyl methacrylamides; and
5 to 50% by weight of repeating units (5) of one or more polymerized monomers M2c selected from the group consisting of polymerized C₁-C₈-alkylesters of acrylic acid and polymerized C₁-C₈-alkylesters of methacrylic acid;
wherein all values given in % by weight refer to the total weight of the polymer P2 and where the total amount of polymerized units (3), (4), and (5) is at least 90% by weight, based on the total weight of the polymer P2;
c) 50 to 84% by weight, based on the total weight of the formulation, of at least one organic solvent as component C, comprising
at least 30% by weight, based on the total weight of the organic solvent, of at least one solvent C.1 selected from the group consisting of 1-(C₁-C₆-alkyl) 2-pyrrolidones, 1-(2-hydroxylethyl)-2-pyrrolidone, C₃-C₆-lactones, dimethyl sulfoxide, 1,3-dimethylimidazolin-2-one, and mixtures thereof; and
optionally up to 70% by weight of one or more solvent C.2, selected from the group consisting of C₂-C₁₀-alkyl esters of C₂-C₄-alkanoic acids, N,N-di(C₁-C₄-alkyl) amides of C₆-C₂₀-alkanoic acids, N—(C₇-C₁₄-alkyl) pyrrolidones, C₄-C₁₀-alkyl lactates, C₁-C₄-alkylesters of C₆-C₂₀ fatty acids, hydrocarbons, acetophenone, and mixtures thereof;
d) at least one anionic surfactant as a component D.

17. The formulation according to claim 1 which is in a form of an emulsifiable concentrate, a dispersible concentrate, or a soluble liquid concentrate.

18. A process for preparing the liquid formulation according to claim 1 which comprises mixing the components A), B), C), and D) to obtain a solution of the component A in the mixture of components B), C), and D).

19. (canceled)

20. A method for controlling growth of undesired plants comprising applying the formulation according to claim 1 onto the undesired plants, on parts of the undesired plants, or on the area where the undesired plants grow or may grow.

21. A method for improving dilution stability of a liquid agricultural formulation of an herbicide of the group of PPO-inhibitors, which comprises including a combination of at least one polymer P1 or P2 as defined in claim 1 and at least one organic solvent C.1 which has a solubility in deionized water of at least 100 g/L as determined at 20° C. and 1 bar into the formulation.
